(19) United States
(12) Patent Application Publication
(10) Pub. No.: US 2021/0100175 A1
(43) Pub. Date: Apr. 8, 2021

(54) Plant Pot Weed Skirt and Plant Wrap

(71) Applicant: Maximilian Wolfgang Guettinger, Kennewick, WA (US)

(72) Inventor: Maximilian Wolfgang Guettinger, Kennewick, WA (US)

(73) Assignee: Maximilian Wolfgang Guettinger, Kennewick, WA (US)

(21) Appl. No.: 16/594,044

(22) Filed: Oct. 6, 2019

(51) Int. Cl. A01G 13/02; A01G 13/10

(52) U.S. Cl. CPC A01G 13/0281; A01G 13/10

(57) ABSTRACT

The invention Plant Pot Skirt and Plant Wrap concerns the prevention of weeds in potted plants as well as further facilitates the protection of plants by offering a wrapping solution. The invention consists of a skirt with tightening straps or hook and loop pads that allow it to wrap around the top of a pot and around the base of the plant that it contains forming a protective apron that deters weeds as well as provides other functions such as insulation. The skirt can also be wrapped around a plant to protect it during transport or during other times when protection is needed.

The invention of this device was not federally sponsored

### BACKGROUND OF THE INVENTION

Weeds are one of the most frustrating banes of gardening, invading gardens and planters with resulting reductions in both aesthetic and functional properties. Although many inventions attempt to address the problem the invention proposed herein is unique in its form which can be tightened around any pot or plant within it, blocking weeds and other pests from the soil that the plant relies on. The invention also has the added benefits of providing insulation for a pot, serving as a trap for moisture escaping from the soil into the surrounding atmosphere, and can even be detached from the pot and used to wrap the stems or foliage of a plant as an added function. In the literature we find that U.S. Pat. No. 4,969,289 issued to Trifiletti, U.S. Pat. No. 2,782,561 issued to Smith, U.S. Pat. No. 3,724,128 issued to Tabone, U.S. Pat. No. 4,934,093 issued to Yanna, U.S. Pat. No. 4,976,063 issued to Young, U.S. Pat. No. 5,367,822 issued to Beckham, U.S. Pat. No. 6,349,500 issued to Popham, and U.S. Pat. No. 6,976,334 issued to Bowditch are examples of edging or skirt type devices placed around plants or planted areas, with a variety of purposes such as weed reduction to water preservation. U.S. Pat. No. 5,396,731 issued to Bryne describes a mulch skirt or mat used to prevent weeds. U.S. Pat. No. 9,198,529 issued to Kramer describes a pot protector. The invention proposed here presents a novel way to prevent weeds as well as having multiple functionalities that present a differing approach to the problem than previous attem pts.

### SUMMARY OF THE INVENTION

The invention comprises a band of fabric, mesh, or other material with two or more drawstrings that can be wrapped around a potted plant and its pot to form a weed deterrent skirt, hook and loop bands sewn to the exterior and interior of the wrapping band can also be used as means of tightening it to itself. The invention can also be used as a plant wrap for transport or other functions. Some presented functions for the invention included insulating pot soil from temperature fluctuations, water conservation, and pest and weed deterrent.

### BRIEF DESCRIPTIONS OF DRAWINGS

FIG. 1 describes a front view of the invention with drawstrings extended.

FIG. 2 describes a top view of the invention when rolled into a semi-cylinder with drawstrings unbound.

FIG. 3 describes a view of a potted plant with the skirt attached. The top portion of the skirt is tightened around the base of the plant using drawstrings with the bottom of the skirt fastened around the top of the pot.

FIG. 4 describes a cross section of FIG. 3 with the invention wrapped around a potted plant.

FIG. 5 describes a rolled version of the invention where hook and loop banding is used as a means of securing it to itself.

### DETAILED DESCRIPTION OF INVENTION

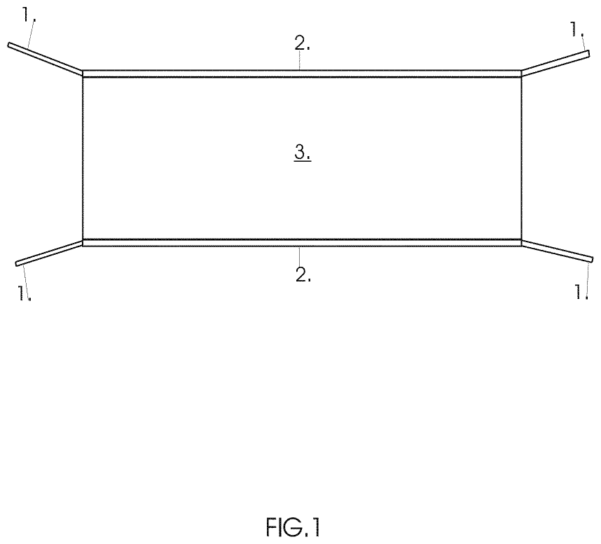

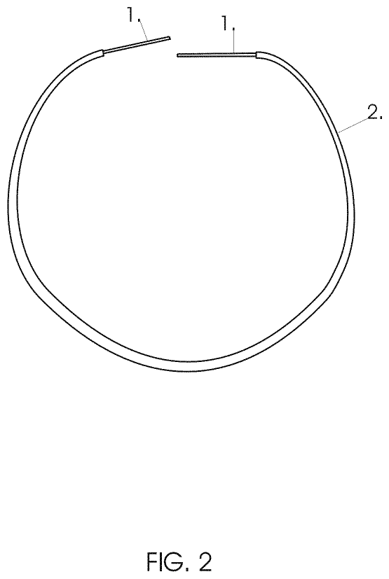

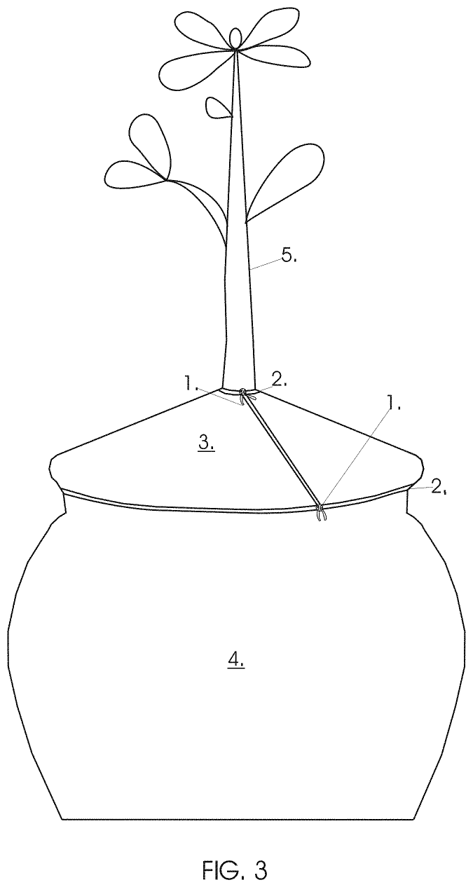

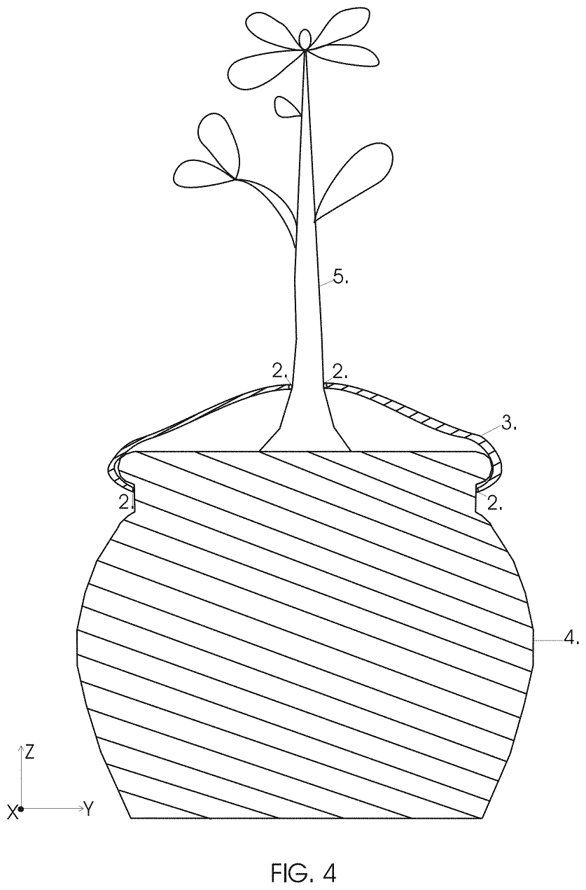

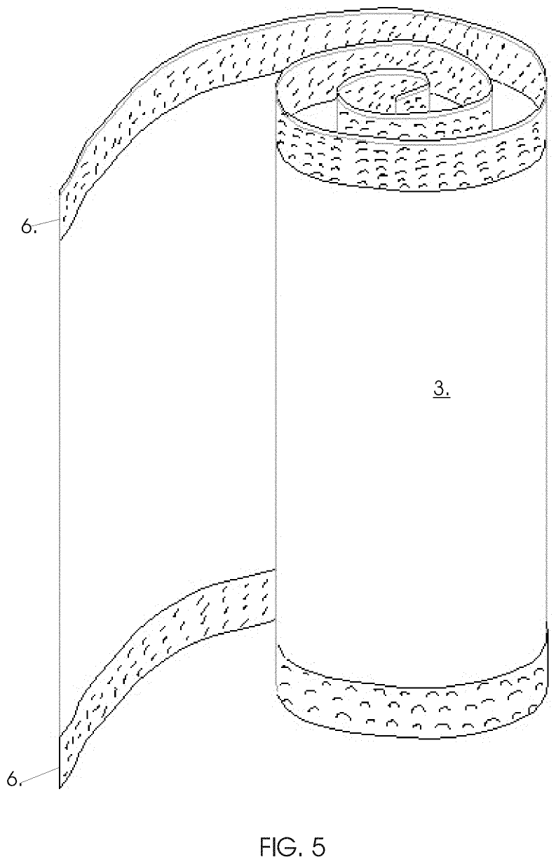

The illustrated drawings shown in the following describe a preferred embodiment of the invention but are not intended to limit its present scope or forms. In reference to FIG. 1 we see a preferred embodiment of the invention with 1 being drawstrings which pass through a tube of folded fabric or other structure 2 that allow the main body of fabric or other material 3 to be tightened around a pot or plant as demonstrated in FIG. 3. FIG. 2 references a view of the invention from the top illustrating its nonridged and flexible nature with drawstrings 1 and drawstring tubes shown 2. FIG. 3 illustrates the invention in use on a plant 5 in a pot 4 with the drawstrings 1 knotted to tighten the main body of the skirt 3 and the drawstring tubes 2 around the pot and plant. FIG. 4 shows as cross-section of FIG. 3 with drawstring tubes 2, main body 3, pot 4, and plant 5. FIG. 5 shows a coiled version of the invention that utilizes hook and loop banding 6 on the main body 3. Although the invention's preferred embodiments have been explained it is understood that further variations and modifications may be made without departing from the spirit and scope of the invention.

1. The invention consists of a method of deterring weeds and providing other functionality such as insulating a potted plant using a wrapping material with a fastening system.

2. The invention is composed of a section of fabric or other material with two or more drawstrings incorporated that allows it to be tightened or wrapped around a plant and the top of its pot.

3. The invention can also be wrapped around a plant with tightened drawstrings to provide it some protection during such times as transport.

4. The invention may use hook and loop banding to achieve the same purpose as the aforementioned drawstrings.
